(19) United States
(12) Patent Application Publication
(10) Pub. No.: US 2008/0182115 A1
(43) Pub. Date: Jul. 31, 2008

(54) Multi-functional circuitry substrates and compositions and methods relating thereto

(76) Inventors: Gary C. Briney, Raleigh, NC (US); Brian C. Auman, Pickerington, OH (US); Christopher J. Milasincic, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/999,664

(22) Filed: Dec. 6, 2007

Related U.S. Application Data
(60) Provisional application No. 60/873,438, filed on Dec. 7, 2006.

(51) Int. Cl. B32B 27/06

(52) U.S. Cl. 428/473.5

(57) ABSTRACT

The invention is directed to substrates for electronic circuitry. The substrates of the invention have a first polyimide layer having a functional filler and a second polyimide layer having a functional filler. The first layer is non-identical to the second layer, and a surface of the first layer is in contact with and is directly bonded to a surface of the second layer. Filler from each layer extends into the interface between the two layers, and a plurality of covalent bonds are present between the first and second functional layers that chemically bond the two layers together to provide a reliable, predictable multifunctional substrate for electronic circuitry with improved performance relative to polyimide layers bonded together by an adhesive.

### FIELD OF INVENTION

The present invention relates generally to multi-layer circuitry substrates having multiple functionality, such as, two or more of the following properties useful in circuitry applications: capacitance, resistance, thermal conductance, electrical conductance, antistatic conductance, and the like. More specifically, circuitry substrates of the present invention comprise two adjacent, integrated, non-identical polyimide layers, which are made to flow together in a precursor state and then imidized to a similar polymer matrix orientation, thereby creating a reliable, predictable, functional bond between the two layers.

### BACKGROUND OF THE INVENTION

Published U.S. Patent Application No. 2005-0280946 to Muro discloses a wiring board having a first polyimide layer of heat-cured photosensitive polyimide, a copper layer pattern formed by growing an electrolytic copper plating layer on the polyimide layer, and a second polyimide layer of heat-cured photosensitive polyimide, the second polyimide layer covering the copper layer pattern

### SUMMARY OF THE INVENTION

The present invention is directed to multilayer polyimide-based composite films comprising (at least): i. a first layer comprising a first polyimide component having dispersed therein a first filler component, and ii. a second layer comprising a second polyimide component having dispersed therein a second filler component. In bonding the two layers directly together, the two layers are placed together in a precursor state where each precursor layer is sufficiently flowable to allow filler to flow into the interface to ultimately reinforce and provide functionality at the bond between the two layers.

### DETAILED DESCRIPTION OF THE PREFERRED EMBODIMENT(S)

In accordance with the present invention, polyimide layers of complimentary properties can be bonded directly together without the need for an adhesive layer, e.g., a thermally conductive polyimide can be combination with an electrically conductive polyimide. The polyimide-based composite film layers of the present invention can have a thickness of between 2 and 300 microns in each layer. The first polyimide component and the second polyimide component may be the same or different, and/or the first filler component and the second filler component may be the same or different, provided that either the polyimide component or the filler component (of each of the two functional layers) is non-identical.

The polyimide composite layers of the present invention can have filler component present in a range between (and optionally also including) any two of the following weight percentages: 1, 3, 5, 10, 25, 35, 40, 50, 60, 70, 75, 85, 90 or 95 weight percent, based upon the entire weight of the functional layer. In one embodiment, the filler components of the present invention is uniformly dispersed so that the average particle size of the filler (in the polyimide component) is generally between about 10, 20, 30, 40 or 50 nanometers to about 1.0, 2.0, 3.0 or 5.0 microns.

The filler component of the present invention can be derived from a dispersion (or solution) of particulate materials (or dissolved materials) either in a solvent or in a solvent mixture further utilizing a dispersing agent.

The filler components of the present invention can be inorganic fillers, organic fillers, ceramic fillers, carbon-based fillers, electrically conductive polymers and electrically conductive (or capacitive) fillers, light-activatable materials, and the like. The purpose of these fillers generally speaking is to add functionality to a polyimide including, but not limited to, improved thermal conductivity, electrical capacitance, electrical conductivity/resistivity, electrical static dissipation, optical properties including color, laser activation (light activation for direct metallization) and more, depending on the filler or combination of fillers chosen.

Optionally, the multilayer polyimide-based composite films of the present invention may comprise additional layers, either filled or unfilled, or either made from a polyimide or other polymer.

The multilayer polyimide composite films of the present invention can be cast using a co-extrusion type process either onto a flat surface (or cast directly onto a metal foil) either in a simultaneously ‘multi-extrusion’ process, or in a sequential extrusion casting process. When cast directly onto a metal foil, these multi-layer polyimide composites can be cured and used as a polyimide-metal laminate material in an electronic device.

The polyimide composite films of the present invention comprise a first functional layer and a second functional layer. The two functional layers are non-identical, where either the polyimide base polymer is different, the filler is different or both the base polymer and filler are different. Each layer contains a polyimide base polymer with a filler interspersed within the base polymer. The filler adds functionality to each layer. The filler also provides improved bonding at the interface between the two layers, if the two layers are placed in contact with one another in a pre-imidized state and then imidized. Upon imidization of the two layers, he polymer orientation of the first polyimide base matrix is sufficiently similar to the orientation of the second polyimide base matrix that the Hermans orientation function value differs by less than 10 percent when measuring the first functional layer as an initial incident layer verses measuring the second functional layer as the initial incident layer.

The presence of the filler near (or spanning) the interface between the two layers, together with imidization, causes the two layers to reliably bond together. During imidization, the filled polymer matrix of each of the two layers will tend to orient similarly and the filler of each layer will tend to reinforce the bond interface. The polymer/filler orientation and the reliable (imidization induced) bond between the layers allows for an advantageous multifunctional composite substrate.

The imidization induced (filler reinforced) bond between the layers provides an effective interface between the two layers, free of unwanted voids or defects along the interface. The interface is highly resistant to delamination, even as circuit traces are imposed upon or through a relatively large percentage of the interface. Furthermore, there will generally be less delamination stress between the circuitry and the two polymer layers, since the filled polymer layers have similar orientation and hence, similar nano-scale movement due to heat, bending, humidity or other conditions imposed upon the circuitry during its useful life.

It has been found that such multifunctional substrates are highly advantageous for supporting circuitry. The circuitry can be designed to connect directly or indirectly to either layer and thereby take advantage of the particular function of such layer. For example, one layer can provide thermal conduction and the other layer capacitance or resistivity. The functionality of each layer can be adjusted through selection and loading of filler (into the precursor layer, prior to imidization) and the particular type of polyimide chosen as the base matrix.

A functional layer of the polyimide composite substrates of the present invention can be filled in any one of a number of ways, such as, to provide thermal conductivity, electrical capacitance, electrical conductivity or resistivity, electrical static dissipation, optical properties including color, laser activation (light activation for direct metallization) or the like. In one embodiment of the present invention, a polyimide composite layer having good thermal conductivity is layered with a second polyimide composite layer having good electrical conductivity. Here, the layer providing good electrical conductivity may have heat removed by the layer having good thermal conductivity.

In another embodiment, a polyimide composite layer having good thermal conductivity is layered with a second polyimide composite layer that can be laser light activatable (i.e. a layer that can be metallized on those portions of the surface that are exposed to laser light). In this instance, the light activatable layer can be laser patterned and then metallized to form a circuit on top of a polyimide composite that is good at conducting heat. In yet another embodiment, a laser light activatable polyimide composite layer can be layered with a second polyimide composite layer having good electrical conductivity. Here, an electrical circuit may be formed directly on top of a second polyimide composite layer designed to be a planar-type electrical sheet resistor material.

The term “polyimide composite” or “polyimide composite layer” as used herein is a combination of at least a polyimide component and a filler component where the filler component is uniformly dispersed in the polyimide component. In the practice of the present invention, at least two polyimide composites (or polyimide composite layers) are used to form a multi-layer composite material. Here, the two composite layers may comprise the same polyimide components or different polyimide components. Generally, the filler component (in these two layers) is different, but in some instances may be the same (i.e. may be the same filler but may be present at different concentrations).

In one embodiment of the present invention, two polyimide composite layers are adjacent to one another. In another embodiment, two polyimide composite layers are separated by a third layer made from a polyimide comprising little, if any, filler or can be made from a material other than a polyimide. In yet another embodiment, a two-layer polyimide composite is adjacent to additional layers (e.g. on one side or on both sides) these additional layers being comprised of a polyimide or other-type material (e.g. an adhesive).

In yet another embodiment of the present invention, a two-layer polyimide composite comprises a third layer where the third layer is also derived from a polyimide or polyimide composite. Here, the third layer can be positioned on the side of the first layer or on the side of the second layer. The third layer (and optionally either the first layer or the second layer) can be derived in part from a polyimide having a glass transition temperature of less than 350° C., or perhaps less than 250° C., and where the polyimide is useful as an adhesive. In such an embodiment, metal layers (either one or two layers) can be bonded to the third layer (and perhaps either the first layer or the second layer) and pressed under heat to form a laminate.

I. Organic Solvents useful for Polyimides

Useful organic solvents for the synthesis of the polyimide composites of the present invention are preferably capable of dissolving polyimide precursor materials (i.e., typical monomers used to form polyimides and their precursor materials). Typically, these solvents can have a relatively low boiling point, such as below 225° C., so the polyimide can be dried at moderate (i.e., more convenient and less costly) temperatures. A boiling point of less than 210, 205, 200, 195, 190, or 180° C. can be preferred. Solvents of the present invention may be used alone or in combination with other solvents (i.e., cosolvents). Useful organic solvents include: N-methylpyrrolidone (NMP), dimethylacetamide (DMAc), N,N′-dimethyl-formamide (DMF), dimethyl sulfoxide (DMSO), tetramethyl urea (TMU), diethyleneglycol diethyl ether, 1,2-dimethoxyethane(monoglyme), diethylene glycol dimethyl ether(diglyme), 1,2-bis-(2-methoxyethoxy)ethane(triglyme), bis[2-(2-methoxyethoxy)ethyl)]ether(tetraglyme), gamma-butyrolactone, and bis-(2-methoxyethyl)ether, tetrahydrofuran. In one embodiment, preferred solvents include N-methylpyrrolidone (NMP) and dimethylacetamide (DMAc). These solvents are also generally used to form the particle dispersions that comprise the filler component of the present invention.

Co-solvents can generally be used at about 5 to 50 weight percent of the total solvent, and useful such co-solvents include xylene, toluene, benzene, “Cellosolve” (glycol ethyl ether), and “Cellosolve acetate” (hydroxyethyl acetate glycol monoacetate). These solvents can also be used as co-solvents in forming the filler component of the present invention.

II. Polyimide Component

As used herein, the term ‘polyimide component’ is intended to include any polyimide precursor material, polyimide, polyimide ester, or polyimide ether ester synthesized by a poly-condensation reaction involving the reaction of at least one or more aromatic or cyclo-aliphatic dianhydrides (or derivations thereof suitable for synthesizing these) with at least one or more aromatic, cycloaliphatic or aliphatic diamines (or derivations thereof suitable for synthesizing these).

Depending upon context, “diamine” as used herein is intended to mean: (i) the unreacted form (i.e., a diamine monomer); (ii) a partially reacted form (i.e., the portion or portions of an oligomer or other polyimide precursor derived from or otherwise attributable to diamine monomer) or (iii) a fully reacted form (the portion or portions of the polyimide derived from or otherwise attributable to diamine monomer). The diamine can be functionalized with one or more moieties, depending upon the particular embodiment selected in the practice of the present invention.

As used herein, an “aromatic diamine” is intended to mean a diamine having at least one aromatic ring, either alone (i.e., a substituted or unsubstituted, functionalized or unfunctionalized benzene or similar-type aromatic ring) or connected to another (aromatic or aliphatic) ring, and such an amine is to be deemed aromatic, regardless of any non-aromatic moieties that might also be a component of the diamine. Hence, an aromatic diamine backbone chain segment is intended to mean at least one aromatic moiety between two adjacent imide linkages. As used herein, an “aliphatic diamine” is intended to mean any organic diamine that does not meet the definition of an aromatic diamine. In one embodiment, useful aliphatic diamines have the following structural formula: H₂N—R—NH₂, where R is an aliphatic moiety, such as a substituted or unsubstituted hydrocarbon in a range from 4, 5, 6, 7 or 8 carbons to about 9, 10, 11, 12, 13, 14, 15, or 16 carbon atoms, and in one embodiment the aliphatic moiety is a C₆ to C₈ aliphatic.

In one embodiment, R is a C₆ straight chain hydrocarbon, known as hexamethylene diamine (HMD or 1,6-hexanediamine). In other embodiments, the aliphatic diamine is an alpha, omega-diamine; such diamines can be more reactive than alpha, beta-aliphatic diamines.

Useful aromatic diamines for example, are selected from the group comprising,
1. 2,2bis-(4-aminophenyl)propane;
2. 4,4′-diaminodiphenyl methane;
3. 4,4′-diaminodiphenyl sulfide;
4. 3,3′-diaminodiphenyl sulfone (3,3′-DDS);
5. 4,4′-diaminodiphenyl sulfone (4,4′-DDS);
6. 4,4′-diaminodiphenyl ether (4,4′-ODA);
7. 3,4′-diaminodiphenyl ether (3,4′-ODA);
8. 1,3-bis-(4-aminophenoxy)benzene (APB-134 or RODA);
9. 1,3-bis-(3-aminophenoxy)benzene (APB-133);
10. 1,2-bis-(4-aminophenoxy)benzene;
11. 1,2-bis-(3-aminophenoxy)benzene;
12. 1,4-bis-(4-aminophenoxy)benzene;
13. 1,4-bis-(3-aminophenoxy)benzene;
14. 1,5-diaminonaphthalene;
15. 1,8-diaminonaphthalene;
16. 2,2′-bis(trifluoromethyl)benzidine;
17. 4,4′-diaminodiphenyldiethylsilane;
18. 4,4′-diaminodiphenylsilane;
19. 4,4′-diaminodiphenylethylphosphine oxide;
20. 4,4′-diaminodiphenyl-N-methyl amine;
21. 4,4′-diaminodiphenyl-N-phenyl amine;
22. 1,2-diaminobenzene (OPD);
23. 1,3-diaminobenzene (MPD);
24. 1,4-diaminobenzene (PPD);
25. 2,5-dimethyl-1,4-diaminobenzene;
26. 2-(trifluoromethyl)-1,4-phenylenediamine;
27. 5-(trifluoromethyl)-1,3-phenylenediamine;
28. 2,2-Bis[4-(4-aminophenoxy)phenyl]-hexafluoropropane (BDAF);
29. 2,2-bis(3-aminophenyl)1,1,1,3,3,3-hexafluoropropane;
30. benzidine;
31. 4,4′-diaminobenzophenone;
32. 3,4′-diaminobenzophenone;
33. 3,3′-diaminobenzophenone;
34. m-xylylene diamine;
35. bisaminophenoxyphenylsulfone;
36. 4,4′-isopropylidenedianiline;
37. N,N-bis-(4-aminophenyl)methylamine;
38. N,N-bis-(4-aminophenyl)aniline
39. 3,3′-dimethyl-4,4′-diaminobiphenyl;
40. 4-aminophenyl-3-aminobenzoate;
41. 2,4-diaminotoluene;
42. 2,5-diaminotoluene;
43. 2,6-diaminotoluene;
44. 2,4-diamine-5-chlorotoluene;
45. 2,4-diamine-6-chlorotoluene;
46. 4-chloro-1,2-phenylenediamine;
47. 4-chloro-1,3-phenylenediamine;
48. 2,4-bis-(beta-amino-t-butyl)toluene;
49. bis-(p-beta-amino-t-butyl phenyl)ether;
50. p-bis-2-(2-methyl-4-aminopentyl)benzene;
51. 1-(4-aminophenoxy)-3-(3-aminophenoxy)benzene;
52. 1-(4-aminophenoxy)-4-(3-aminophenoxy)benzene;
53. 2,2-bis-[4-(4-aminophenoxy)phenyl]propane (BAPP);
54. bis-[4-(4-aminophenoxy)phenyl]sulfone (BAPS);
55. 2,2-bis[4-(3-aminophenoxy)phenyl]sulfone (m-BAPS);
56. 4,4′-bis-(aminophenoxy)biphenyl (BAPB);
57. bis-(4-[4-aminophenoxy]phenyl)ether (BAPE);
58. 2,2′-bis-(4-aminophenyl)-hexafluoropropane (6F diamine);
59. bis(3-aminophenyl)-3,5-di(trifluoromethyl)phenylphosphine oxide
60. 2,2′-bis-(4-phenoxy aniline)isopropylidene;
61. 2,4,6-trimethyl-1,3-diaminobenzene;
62. 4,4′-diamino-2,2′-trifluoromethyl diphenyloxide;
63. 3,3′-diamino-5,5′-trifluoromethyl diphenyloxide;
64. 4,4′-trifluoromethyl-2,2′-diaminobiphenyl;
65. 4,4′-oxy-bis-[(2-trifluoromethyl)benzene amine];
66. 4,4′-oxy-bis-[(3-trifluoromethyl)benzene amine];
67. 4,4′-thio-bis-[(2-trifluoromethyl)benzene-amine];
68. 4,4′-thiobis-[(3-trifluoromethyl)benzene amine];
69. 4,4′-sulfoxyl-bis-[(2-trifluoromethyl)benzene amine;
70. 4,4′-sulfoxyl-bis-[(3-trifluoromethyl)benzene amine];
71. 4,4′-keto-bis-[(2-trifluoromethyl)benzene amine];
72. 9,9-bis(4-aminophenyl)fluorene;
73. 1,3-diamino-2,4,5,6-tetrafluorobenzene;
74. 3,3′-bis(trifluoromethyl)benzidine;
75. 3,3′-diaminodiphenylether;
76. and the like.

Useful aliphatic diamines used in conjunction with either an aromatic diamine, or used alone as the remaining diamine of the diamine component include (but are not limited to) 1,6-hexamethylene diamine, 1,7-heptamethylene diamine, 1,8-octamethylenediamine, 1,9-nonamethylenediamine, 1,10-decamethylenediamine (DMD), 1,11-undecamethylenediamine, 1,12-dodecamethylenediamine (DDD), 1,16-hexadecamethylenediamine, 1,3-bis(3-aminopropyl)-tetramethyldisiloxane, α,ω-bis(3-aminopropyl)polydimethylsiloxane, isophoronediamine, and combinations thereof. Any cycloaliphatic diamine can also be used.

In one embodiment of the present invention (in order to achieve a low temperature bonding) diamines comprising ether linkages and or diamines comprising aliphatic functional groups are used. The term low temperature bonding is intended to mean bonding two materials in a temperature range of from about 180, 185, or 190° C. to about 195, 200, 205, 210, 215, 220, 225, 230, 235, 240, 245 and 250° C.).

Similarly, the term dianhydride as used herein is intended to mean a component that reacts with (or is complimentary to) a diamine, and in combination is capable of reacting to form an intermediate polyamic acid (which can then be cured into a polyimide). Depending upon the context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e., a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polyimide composition reacted from or otherwise attributable to dianhydride monomer) or (iii) a fully reacted form (the portion or portions of the polyimide derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polyimide). Such additional anhydride moieties could be used to crosslink the polymer or to provide other functionality to the polymer.

Useful dianhydrides of the present invention include aromatic dianhydrides. These aromatic dianhydrides include, (but are not limited to),
1. pyromellitic dianhydride (PMDA);
2. 3,3′,4,4′-biphenyl tetracarboxylic dianhydride (BPDA);
3. 3,3′,4,4′-benzophenone tetracarboxylic dianhydride (BTDA);
4. 4,4′-oxydiphthalic anhydride (ODPA);
5. 3,3′,4,4′-diphenylsulfone tetracarboxylic dianhydride (DSDA);
6. 2,2-bis(3,4-dicarboxyphenyl)1,1,1,3,3,3-hexafluoropropane dianhydride (6FDA);
7. 4,4′-(4,4′-isopropylidenediphenoxy)bis(phthalic anhydride) (BPADA);
8. 2,3,6,7-naphthalene tetracarboxylic dianhydride;
9. 1,2,5,6-naphthalene tetracarboxylic dianhydride;
10. 1,4,5,8-naphthalene tetracarboxylic dianhydride;
11. 2,6-dichloronaphthalene-1,4,5,8-tetracarboxylic dianhydride;
12. 2,7-dichloronaphthalene-1,4,5,8-tetracarboxylic dianhydride;
13. 2,3,3′,4′-biphenyl tetracarboxylic dianhydride;
14. 2,2′,3,3′-biphenyl tetracarboxylic dianhydride;
15. 2,3,3′,4′-benzophenone tetracarboxylic dianhydride;
16. 2,2′,3,3′-benzophenone tetracarboxylic dianhydride;
17. 2,2-bis(3,4-dicarboxyphenyl)propane dianhydride;
18. 1,1-bis(2,3-dicarboxyphenyl)ethane dianhydride;
19. 1,1-bis(3,4-dicarboxyphenyl)ethane dianhydride;
20. bis-(2,3-dicarboxyphenyl)methane dianhydride;
21. bis-(3,4-dicarboxyphenyl)methane dianhydride;
22. 4,4′-(hexafluoroisopropylidene)diphthalic anhydride;
23. bis-(3,4-dicarboxyphenyl)sulfoxide dianhydride;
24. tetrahydrofuran-2,3,4,5-tetracarboxylic dianhydride;
25. pyrazine-2,3,5,6-tetracarboxylic dianhydride;
26. thiophene-2,3,4,5-tetracarboxylic dianhydride;
27. phenanthrene-1,8,9,10-tetracarboxylic dianhydride;
28. perylene-3,4,9,10-tetracarboxylic dianhydride;
29. bis-1,3-isobenzofurandione;
30. bis-(3,4-dicarboxyphenyl)thioether dianhydride;
31. bicyclo[2,2,2]oct-7-ene-2,3,5,6-tetracarboxylicdianhydride;
32. 2-(3′,4′-dicarboxyphenyl)5,6-dicarboxybenzimidazole dianhydride;
33. 2-(3′,4′-dicarboxyphenyl)5,6-dicarboxybenzoxazole dianhydride;
34. 2-(3′,4′-dicarboxyphenyl)5,6-dicarboxybenzothiazole dianhydride;
35. bis-(3,4-dicarboxyphenyl)2,5-oxadiazole1,3,4-dianhydride;
36. bis-2,5-(3′,4′-dicarboxydiphenylether)1,3,4-oxadiazole dianhydride;
37. bis-2,5-(3′,4′-dicarboxydiphenylether)1,3,4-oxadiazole dianhyd ride;
38. 5-(2,5-dioxotetrahydro)-3-methyl-3-cyclohexene-1,2-dicarboxylic anhydride;
39. trimellitic anhydride2,2-bis(3′,4′-dicarboxyphenyl)propane dianhydride;
40. 1,2,3,4-cyclobutane dianhydride;
41. 2,3,5-tricarboxycyclopentylacetic acid dianhydride;
42. their acid ester and acid halide ester derivatives;
43. and the like.

The dianhydride and diamine components of the present invention are particularly selected to provide the polyimide binder with specifically desired properties. One such useful property is for the polyimide binder to have a certain glass transition temperature (Tg). A useful Tg can be between and including any two of the following numbers, 350, 325, 300, 275, 250, 240, 230, 220, 210, 200, 190, 180, 170, 160, 150, 140, 130, 120, 110 and 100° C. Another useful range, if adherability is less important than other properties, is from 550, 530, 510, 490, 470, 450, 430, 410, 390, 370, 350, 330, 310, 290, 270, and 250° C. In some cases, a polysiloxane diamine can be used in a mole ratio (compared to the second diamine) so that the polyimide binder has lower Tg. In another case, where low Tg is required, less polysiloxane diamine can be used so long as certain flexible diamines are chosen. Useful diamines here can include APB-134, APB-133, 3,4′-ODA, BAPP, BAPE, BAPS and many aliphatic diamines. As such, the selection of dianhydride and diamine component is important to customize what final properties of the polymer binder are specifically desired.

In one embodiment of the present invention useful dianhydrides include BPADA, DSDA, ODPA, BPDA, BTDA, 6FDA, and PMDA or mixtures thereof. These dianhydrides are readily commercially available and generally provide acceptable performance.

Ultimately, the precursor (polyamic acid) is converted into a high-temperature polyimide material having a solids content greater than about 99.5 weight percent. At some point in the process, the viscosity of the mixture is increased beyond the point where the filler material can be blended with the polyimide precursor. Depending upon the particular embodiment herein, the viscosity of the mixture can possibly be lowered again by diluting the material, perhaps sufficiently enough to allow dispersion of the filler material into the polyimide precursor.

Polyamic acid solutions can be converted to high temperature polyimides using processes and techniques commonly known in the art such as heat or conventional polyimide conversion chemistry. Such polyimide manufacturing processes have been practiced for decades. The amount of public literature on polyimide manufacture is legion and hence further discussion herein is unnecessary. Any conventional or non-conventional polyimide manufacturing process can be appropriate for use in accordance with the present invention provided that a precursor material is available having a sufficiently low viscosity to allow filler material to be mixed. Likewise, if the polyimide is soluble in its fully imidized state, filler can be dispersed at this stage prior to forming into the final composite.

III. Filler Component(s)

As used herein, the term “filler component” is intended to mean a substance that can be dispersed in or throughout the polyimide component. ‘Filler component’ is intended to include any dry particle or particle-in-liquid dispersion, such as, inorganic fillers, organic fillers, ceramic fillers, carbon-based fillers, metal fillers, electrically conductive polymers and the like where the particles are dispersed in an organic solvent either alone, with other fillers, with a dispersing agent, with a cosolvent, or with a polymer suspension agent. Typically, these dispersions are mixed well enough so that the average particle size of the filler particles is adequately reduced in order to form a stable dispersion that when mixed with the polyimide component will form a polyimide composite that is functional in the desired application. The combination of the polyimide component and the filler component is referred to herein as a polyimide composite or polyimide composite layer.

In one embodiment of the present invention, a filler component is uniformly dispersed so that the average particle size of the filler in an organic solvent compatible with the polyimide component is between greater than about 10, 20, 30, 40 or 50 nanometers to less than about 1.0, 2.0, 3.0, 5.0 or 10 microns. A filler component that is not adequately dispersed (e.g. a filler component that contains large agglomerates) can oftentimes degrade or defeat the functional aspects sought after in the polyimide composite.

In one embodiment of the present invention, the filler particles have a diameter in a range between and including any two of the following (in microns): 0.002, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 5.0 and 10.0 microns.

The filler component can be mixed with a polyimide precursor material. Precursor materials include, but are not limited to polyamic acids, solvents containing monomers used to form a polyimide, and solvents containing a soluble polyimide.

In one embodiment of the present invention, a dispersing agent is used to assist the incorporation of the filler component into a polyamic acid. In one such embodiment, a dispersing agent is added to an organic solvent, or co-solvent mixture (or solvent system) to form a dispersing solution. The dispersion solution comprises some concentration of dispersing agent typically between any two of the following numbers 0.1, 0.5, 1.0, 2.0, 4.0, 5.0, 10.0, 15.0 and 20.0 weight percent dispersing solution. The dispersing solution can then be used to disperse (along with shearing force if necessary) the filler component into the solvent.

In one embodiment of the present invention, the filler component is derived from a dispersion (in an organic solvent compatible with a polyimide precursor material) an inorganic filler, organic filler, ceramic filler carbon-based filler, metal filler, or electrically conductive polymer. The filler is dispersed into an organic solvent (or co-solvent or mixture of solvents and co-solvents) to form a stable particle dispersion containing anywhere from about 1 to 95 weight-percent filler. The filler is typically well dispersed, (i.e., dispersed to an average particle size of about 20 to 20,000 nanometers), or to the level in which the average particle size of the filler is controlled to prevent an unwanted level of agglomeration. Unwanted agglomerated filler can typically be ground down to a size where the advantageous properties of a polyimide composite is not adversely affected (i.e., good dielectric strength, good mechanical properties, and good adhesivity to other materials) via a variety of commonly known dispersion techniques (e.g., milling). Typically, the average particle size of the filler component of the present invention (after grind, or using a dispersing agent, or both) is between and including any two of the following numbers (in microns): 0.02, 0.10, 0.20, 0.50, 0.80, 1.0, 2.0 and 5.0 microns.

Useful fillers of the present invention include, but are not limited to,
1. aluminum oxide,
2. copper oxide,
3. silver oxide,
4. ruthenium oxide,
5. silica,
6. boron nitride,
7. boron nitride coated aluminum oxide,
8. granular alumina,
9. granular silica,
10. fumed silica,
11. silicon carbide,
12. aluminum nitride,
13. titanium dioxide,
14. dicalcium phosphate,
15. barium titanate,
16. barium strontium titanate,
17. barium nitride,
18. aluminum nitride,
19. beryllium oxide,
20. diamond titanium nitride carbide,
21. zirconium boride carbide,
22. tungsten boride silicon carbide,
23. diamond,
24. carbon black,
25. carbon nanotubes,
26. multi-wall carbon nanotubes,
27. carbon fiber,
28. carbon nanofibers,
29. graphite,
30. electrically conductive polymers,
31. palladium,
32. gold,
33. platinum,
34. nickel,
35. silver,
36. copper,
37. paraelectric filler powders like Ta2O5, HfO2, and Nb2O5,
38. steatite,
39. perovskites of the general formula ABO3,
40. spinels of the general formula AB2O4,
41. lead zirconate titanate (PZT),
42. lead lanthanum titanate,
43. lead lanthanum zirconate titanate (PLZT),
44. lead magnesium niobate (PMN),
45. calcium copper titanate,
46. bentonite,
47. calcium carbonate,
48. iron oxide,
49. mica,
50. glass,
51. talc,
52. fumed alumina,
53. boron nitride coated aluminum nitride,
54. aluminum oxide coated aluminum nitride,
55. other metal oxides derived from any of these elements Pt, Ir, Sr, La, Nd, Ca, Cu, Bi, Gd, Mo, Nb, Cr and Ti,
56. and mixtures of these.

IV. Incorporating the Filler into a Polyimide Matrix

Generally, the filler component of the present invention can be prepared by dispersing filler into a solvent to form slurry. The slurry can then dispersed in a polyamic acid (i.e. a polyimide precursor) or soluble polyimide solution either alone or with the aid of a dispersing agent. This mixture can be referred to as a filled polyamic acid or filled polyimide casting solution.

The filled polyamic acid casting solution is typically a blend of a pre-formed polyamic acid solution and filler. In one embodiment, the filler is first dispersed in the same polar aprotic solvent used to make the polyamic acid solution (e.g. DMAc). Optionally, a small amount of polyamic acid solution may be added to a slurry comprising filler material to either increase the viscosity of the slurry, improve dispersion, or stabilize the slurry from unwanted particle agglomeration.

In one embodiment, the filler slurry is blended with a polyamic acid solution to form the filled polyamic acid casting solution. This blending operation can include high sheer mixing. The polyamic acid casting solution can optionally further comprise additional additives, including processing aids (e.g., placticizers), antioxidants, light stabilizers, flame retardant additives, anti-static agents, heat stabilizers, ultraviolet absorbing agents, other inorganic and organic fillers or various reinforcing agents. The polyamic acid casting solution can be cast, or applied onto, a support such as an endless metal surface or rotating drum. A wet film then formed by heating the solution to remove some of the solvent. The wet film, sometimes called a ‘green’ film is converted into a self-supporting film by baking at an appropriate temperature where the solids are from 60, 65, 70, 75, 80, 85, and 90 weight percent. The green film can be separated from the support and then cured (e.g. in a tentering process) with continued thermal energy (i.e. convective and/or radiant) curing. This process can produce a multilayer polyimide composite film that has a well cured polyimide binder wherein the total solids (i.e. the polyimide binder and the filler combined) has a weight-percent solids of above 98.5, 99.0 or 99.5%.

Other useful methods for producing polyimide films in accordance with the present invention can be found in U.S. Pat. Nos. 5,166,308 and 5,298,331 and are incorporated by reference into this specification for all teachings therein.

Other techniques of producing polyimide precursor materials include, but are not limited to,

(a) A method wherein the diamine monomers and dianhydride monomers are preliminarily mixed together and then the mixture is added in portions to a solvent while stirring.

(b) A method wherein a solvent is added to a stirring mixture of diamine and dianhydride monomers (contrary to (a) above).

(c) A method wherein diamines are exclusively dissolved in a solvent and then dianhydrides are added thereto at such a ratio as allowing to control the reaction rate.

(d) A method wherein the dianhydride monomers are exclusively dissolved in a solvent and then amine components are added thereto at such a ratio to allow control of the reaction rate.

(e) A method wherein the diamine monomers and the dianhydride monomers are separately dissolved in solvents and then these solutions are mixed in a reactor.

(f) A method wherein the polyamic acid with excessive amine component and another polyamic acid with excessive anhydride component are preliminarily formed and then reacted with each other in a reactor, particularly in such a way as to create a non-random or block copolymer.

(g) A method wherein a specific portion of the amine components and dianhydride components are first reacted and then residual dianhydride monomer is reacted, or vice versa.

(h) A method wherein the filler particles are dispersed in a solvent and then injected into a stream of polyamic acid to form a filled polyamic acid casting solution and then cast to form a green film. This can be done with a high molecular weight polyamic acid or with a low molecular weight polyamic acid which is subsequently chain extended to a high molecular weight polyamic acid.

(i.) A method wherein the components are added in part or in whole in any order to either part or whole of the solvent, also where part or all of any component can be added as a solution in part or all of the solvent.

(j) A method of first reacting one of the dianhydride monomers with one of the diamine monomers giving a first polyamic acid, then reacting the other dianhydride monomer with the other amine component to give a second polyamic acid, and then combining the amic acids in any one of a number of ways prior to film formation.

In one embodiment, it is preferable to use a heating system having a plurality of heating sections or zones. It is also generally preferable that the maximum heating temperature be controlled to give a maximum air (or nitrogen) temperature of the ovens from about 200 to 600° C., more preferably from 350 to 500° C. By regulating the maximum curing temperature of the green film within the range as defined above, it is possible to obtain a polyimide film that has excellent mechanical strength, adhesive character, and thermal dimensional stability.

Alternatively, heating temperatures can be set to between 200-600° C. while varying the heating time. Regarding curing time, it can be preferable that the polyimides of the present invention be exposed to a maximum heating temperature for about 1, 2, 3, 5, 10, 15, 20, 25, 30, 35, 40, 45 or 50 seconds to about 60, 70, 80, 90, 100, 200, 400, 500, 700, 800, 900, 1000, 1100 or 1200 seconds (the length of time depending on heating temperature). The heating temperature may be changed stepwise so as not to wrinkle a film by drying it too quickly.

The thickness of the multilayer polyimide composite films of the present invention may be adjusted depending on the intended use of the film (i.e. or final application specifications desired). Depending upon design criteria, total film thicknesses can be in a range between (and including) any two of the following film thicknesses: 2, 5, 8, 10, 15, 20, 25, 30, 35, 40, 45, 50, 60, 80, 100, 125, 150, 175, 200, 300, 400 and 500 microns. In one embodiment, the total thickness of a multilayer composite film is from about 12 to about 125 microns, or about 15 to 25 microns.

Generally, the polyamic acids of the present invention (when cured to form a polyimide) can form polymer that is useful as an adhesive, i.e. can form a polyimide polymer having a glass transition temperature between about 150° C. and 300° C. Typically these polyamic acids (along with an inert filler component) can be dried of solvent, and heated at higher temperatures, to form a polyimide adhesive composite (via a polycondensation reaction known as imidization).

In one embodiment of the present invention, a polyimide composite layer is formed having dispersed therein an amount of filler component between (and including) any two of the following numbers, 1, 2, 5, 10, 15, 20, 25, 30, 35, 40, 45, 50, 55, 60, 65, 70 and 75 weight percent to about 90 to 95 weight percent (based on the total weight of the polyimide composite).

In another embodiment of the present invention, a first polyimide composite layer is used to form in part a multi-layer polyimide construction also having a second polyimide composite layer. The second polyimide composite layer may have the same polyimide component, or different polyimide component, than the first composite layer. Generally speaking, the second polyimide composite layer may have a different filler component (or may have the same filler component but at a different filler loading level) than the first polyimide composite layer. Alternatively, the filler components of each layer may be the same (and may be present at the same loading level) and the polyimide component may be different. In general, the amount of filler component in the first layer and the second layer can be tailored towards a particular functional specification or engineering application.

The present invention does not necessarily depend on the first polyimide and second polyimide composite layers to be adjacent to one another. A third layer can separate these two composite layers. The third layer can either comprise another polymer (i.e. a polymer other than a polyimide) or may be a polyimide having little to no filler component or having a different filler component. These other polymers can be epoxies, bismaleimides, bismaleimide triazines, fluoropolymers, polyesters, polyphenylenes oxide/polyphenylene ethers, polybutadiene/polyisoprene crosslinkable resins, liquid crystal polymers, polyamides and cyanate esters.

In one embodiment of the present invention, a first polyimide composite layer and a second polyimide composite layer are simultaneously cast via co-extrusion. The cast solutions making up these layers can be an uncured polyamic acid composite film derived from blending a filler component with a polyimide precursor material (typically a polyamic acid) after which the precursor material is cured to a polyimide. In one embodiment, filler material can be put in the outer layers of the multilayer composite, the inner layers (or in some of the inner layers), or in at least one outer layer and at least one inner layer. In addition, the concentration (or “filler loading”) of the filler component can be different, or can the same, in each composite layer depending on the final properties desired. In one embodiment, a low Tg polyimide composite layer (containing a low Tg polyimide) is used in conjunction with a second layer using a high Tg polyimide. In another embodiment, a three-layer polyimide is formed having two outer layers comprise a low Tg polyimide and an inner layer comprises a high Tg polyimide, each layer comprising a filler component. In one embodiment, these layers can be cast simultaneously or cast sequentially (e.g. cast onto a metal foil).

In general a polyimide composite layer of the present invention can be used in a variety of applications and uses. One use for example is where the polyimide composite layer has superior thermal conductivity than a polyimide, i.e. where the filler component is an inorganic particle having a thermal conductivity of between and including any two of the following numbers, 1, 10, 50, 100, 150, 200, 500, 1000, 1200, 1500, 2000, 5000, 10,000, 20,000, 100,000, 500,000 and 1,000,000 watts/(meter*K) where the layer has a thermal conductivity of between and including any two of the following numbers 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 4.0, 6.0, 8.0, 10.0, 20.0, 50.0, 100, 150 and 200 watts/(meter*K). In addition, the polyimide composite layers of the present invention can be used as capacitor layer, i.e. a material having a dielectric constant of between and including any two of the following numbers, 2, 4, 10, 20, 50, 100, 150, 200, 250, 300, 350, 400, 450, 500 where the filler (e.g. paraelectric fillers or ferroelectric fillers) can typically have a dielectric constant between any two of these numbers 10, 20, 50, 100, 500, 1000, 2000, 5000, 10,000 and 50,000. Furthermore, the composite layers of the present invention can be used as an electrically conductive layer where the layer has an electrical resistivity of between 1×101 to 1×1014 ohms*m.

The multilayer polyimide composites of the present invention are excellent dielectrics that can be useful in forming a polyimide-metal laminate, or may also be used as a stand-alone film in other designs requiring good thermal conductivity from a dielectric.

In a further embodiment, a polyamic acid-based slurry (i.e. slurry of filler) may be coated on a fully cured polyimide base film or directly on a metal substrate and subsequently imidized by heat treatment. The polyimide base film may be prepared by either a chemical process or thermal conversion process and may be surface treated (e.g. by chemical etching, corona treatment, laser etching etc., to improve adhesion).

A single polyimide metal-clad of the present invention can typically comprise a flexible multilayer polyimide composite adhered to a metal foil, foils such as copper, aluminum, nickel, steel or an alloy foil containing one or more of these metals. In some cases, the polyimide composite layer can adhere firmly to the metal, having a peel strength of greater than 2 pounds per linear inch and higher, without using an adhesive. The metal may be adhered to one or both sides of the multilayer polyimide composite. In other cases, an adhesive can be used to laminate the multilayer polyimide composite film to a metal layer. Common adhesives used to bond the multilayer polyimide composite films to a metal foil (if an adhesive is needed) can be a polyimide-based adhesive, an acrylic-based adhesives, or epoxies. For example, when the polyimide component has a Tg of about 250° C. or less, the polyimide binder itself can act as a good adhesive. These polyimide adhesive films can bond to copper at from about 2 pounds per linear inch to about 15 pounds per linear inch when the bonding temperatures between 150° C. and 350° C. are used.

A practitioner of the present invention may prepare compositions in accordance with the below methodology and below materials. In one embodiment, a polyamic acid solution is prepared and then mixed with a filler component derived from a filler material dispersed in a solvent compatible with a polyamic acid. Here a polyamic acid composite mixture is formed. The polyamic acid composite mixture can then be cast and cured (with thermal energy or radiant energy) to form a polyimide composite layer. In the practice of the present invention, at least two different polyimide composite layers are layered together to form a multilayer composite.

Some examples of suitable polyimide composite layers used in the practice of this invention are described, in Table 1 below. Quantities of ingredients (i.e. ratios of one ingredient to another ingredient) may be adjusted to tailor the final properties of the composite layer. In addition, ingredients may be substituted or blended with other ingredients to form similar-type polyimide composites described herein.

Generally speaking, polyimide composite layers useful in the practice of the present invention can be described as a(n),

TABLE 1

| Name | General Formulation | |
|---|---|---|
| Thermally Conductive PI | 50 | wt % alumina // 50 wt % PI |
| Composite | | |
| Anti-static PI Composite | 15 | wt % carbon // 85 wt % PI |
| Resistive Heater PI Composite | 25 | wt % carbon // 75 wt % PI |
| Resistor PI Composite | 80 | wt % carbon // 20 wt % PI |
| Electrically Conductive PI | 8.0 | wt % doped polyaniline // |
| Composite | 92 | wt % PI |
| High-K PI Composite | 60 | wt % barium titanate // 40 wt % |
| | | PI |
| Low-K PI Composite | 90 | wt % fluoropolymer // 10 wt % |
| | | PI |
| Light Activatable PI Composite | 5.0 | wt % spinel crystal // 95 wt % PI |

Thermally conductive polyimide composite (as described above) may contain from about 30 weight percent to about 90 weight percent thermally conductive filler (e.g. alumina or boron nitride). ‘Anti-static’ and resistive heater polyimide composites (as described above) may comprise from about 2 to 50 weight-percent carbon particles (depending on the particular type of carbon chosen). Electrical resistor compositions can comprise from 20 to about 90 weight percent carbon. In addition, electrically conductive polyimide composites may comprise other electrically conductive polymers (other than polyaniline) either having, or not having, a suitable dopant used to adjust electrical conductivity of the filler. Furthermore, electrically conductive polymers (ECP's) may be used in an amount anywhere between from about 2 to 25 weight percent. High-K polyimide composites (as described above) may comprise high-K fillers (e.g. barium titanate) in an amount between from about 30 to about 95 weight-percent and low-K polyimide composites may comprise a fluoropolymer-based filler present in amount ranging from about 50 to 95 weight percent. Finally, light activatable polyimide composites (as described above) may comprise a spinel crystal-type filler in an amount ranging from about 2 to 20 weight-percent.

In one embodiment of the present invention, a thermally conductive polyimide composite is layered with an electrically conductive polyimide composite layer. The electrically conductive layer may be used as a base layer to form seat heater in an automobile. The thermally conductive layer may be used to conduct excess heat away for circuitry components or other materials.

In another embodiment, a high-K polyimide composite layer is layered with a second layer comprising an electrically conductive composite. Here, the high-K layer may be used as a planar capacitor in an electronic circuit package, while the electrically conductive layer might be used as an electrical static charge dissipation layer or may be used as a planar-type electrical resistor material.

In yet another embodiment, a light activatable polyimide composite may be used comprising a spinel crystal filler used for efficient and accurate surface patterning (through activation by a laser or other similar type light patterning technique) prior to a bulk metallization step complimentary to said laser patterning. These spinel crystal fillers typically comprise two or more metal oxide cluster configurations within a definable crystal formation, the overall crystal formation (when in an ideal, i.e., non-contaminated, non-derivative state) will have the following general formula, AB204. as one layer in a two-layer structure also comprising an electrically conductive layer. In a multilayer polyimide composite, an electrically conductive layer may be used as a static dissipation layer or perhaps as a planar-type electrical resistor in addition to using a light activatable polyimide composite layer. In addition, the electrically conductive layer may be substituted (or added with) a thermally conductive layer where circuitry may be formed on the light activatable layer and where heat (generated by this circuit) may be removed by an adjacent thermally conductive polyimide composite layer.

As used herein, the term “conductive layers” and “conductive foils” are meant to be metal layers or metal foils. Conductive foils are typically metal foils. Metal foils do not have to be used as elements in pure form; they may also be used as metal foil alloys, such as copper alloys containing nickel, chromium, iron, and other metals. Other useful metals include, but are not limited to, copper, nickel, steel, aluminum, brass, a copper molybdenum alloy, Kovar®, Invar®, a bimetal, a trimetal, a tri-metal derived from two-layers of copper and one layer of Invar®, and a trimetal derived from two layers of copper and one layer of molybdenum.

The conductive layers may also be metals or metal alloys which can be applied to the polyimides of the present invention via a sputtering or vapor deposition step, optionally followed by an electro-plating step. In these types of processes, a metal seed coat layer (or layers) is first sputtered (or vapor deposited) onto the polyimide adhesive. Finally, a thicker coating of metal is applied to the seed coat(s) via electro-plating or electro-deposition. Metal layers so applied may also be hot pressed above the glass transition temperature of the polymer for enhanced peel strength.

A polyimide-metal laminate in accordance with the present invention may also be formed by applying a polyamic acid to metal foil, and then subsequently drying and curing the polyamic acid to form a polyimide. These single-side laminates also can be laminated together (for instance where the polyimide sides are place in contact with one another) to form a double metal laminate. Particularly suitable metallic substrates are foils of rolled annealed copper (RA copper), electro-deposited copper (ED copper), or rolled annealed copper alloy. In many cases, it has proved to be of advantage to treating the metallic substrate before coating. This treatment may include, but is not limited to, electro-deposition or immersion-deposition on the metal of a thin layer of copper, zinc, chrome, tin, nickel, cobalt, other metals, and alloys of these metals. The pretreatment may consist of a chemical treatment or a mechanical roughening treatment. It has been found that this pretreatment enables the adhesion of the polyimide layer and, hence, the peel strength to be further increased. Apart from roughening the surface, the chemical pretreatment may also lead to the formation of metal oxide groups, enabling the adhesion of the metal to the polyimide layer to be further increased. This pretreatment may be applied to both sides of the metal, enabling enhanced adhesion to substrates on both sides.

A polyimide metal-clad of the present invention can also be prepared by laminating copper foil to one side or both sides of an adhesive coated composite polyimide film or directly to a polyimide composite film whose surface is amenable to lamination and bonding (e.g. a low-Tg polyimide-based composite). These constructions can also be made by laminating an adhesive coated copper foil to both sides of a composite polyimide film or to an adhesive coated composite polyimide film.

In another embodiment, the polyimide composite can be a discrete layer in a multi-polyimide layer film construction. For instance, the composite layer can be co-extruded as one layer in a two-layer polyimide, or as the outside layers (or inside layer) in a three-layer polyimide (see also U.S. Pat. No. 5,298,331, herein incorporated by reference).

In another embodiment, the polyimides of the present invention can be used as a material used to construct a planar transformer component. These planar transformer components are commonly used in power supply devices. In yet another embodiment, the polyimide adhesives of the present invention may be used with thick metal foils (like Inconel) to form flexible heaters. These heaters are typically used in automotive and aerospace applications.

Generally, the polyimide film composites of the present invention are useful as a single-layer base substrate (a dielectric) in an electronic device requiring good thermal conductivity of the dielectric material. Examples of such electronic devices include (but are not limited) thermoelectric modules, thermoelectric coolers, DC/AC and AC/DC inverters, DC/DC and AC/AC converters, power amplifiers, voltage regulators, igniters, light emitting diodes, IC packages, and the like.

What is claimed is:

1. A substrate for electronic circuitry, comprising:
a. a first functional layer comprising a first filler and a first polyimide base matrix, the first filler being present in an amount within a range from 1 and 95 weight percent based upon the total weight of the first functional layer; and
b. a second functional layer comprising a second filler and a second polyimide base matrix, the second filler being present in an amount within a range from 1 and 95 weight percent based upon the total weight of the second functional layer,
the first functional layer being non-identical to the second functional layer, and a surface of the first functional layer being in contact with and being directly bonded to the second functional layer with an interface between the two layers,
a plurality of the first filler and a plurality of the second filler extending into the interface between the two layers, and a plurality of covalent bonds being present between the first and second functional layers that chemically bond the first functional layer to the second functional layer.

2. A substrate for electronic circuitry in accordance with claim 1, wherein the first polyimide base matrix is the same as the second polyimide base matrix, and the first filler is different than the second filler.

3. A substrate for electronic circuitry in accordance with claim 1, wherein the first filler is the same as the second filler, and the first polyimide base matrix is different than the second polyimide base matrix.

4. A substrate for electronic circuitry in accordance with claim 1, further comprising a metalized circuitry having a first portion that extends into the first functional layer and a second portion which is the same or different from the first portion that extends into the second functional layer, wherein both the first polyimide matrix and the second polyimide matrix have a glass transition temperature between and including 150° and 350° C.

5. A substrate for electronic circuitry in accordance with claim 1, wherein the polymer orientation of the first polyimide base matrix is sufficiently similar to the orientation of the second polyimide base matrix that the Hermans orientation function value differs by less than 10 percent when measuring the first functional layer as an initial incident layer verses measuring the second functional layer as the initial incident layer.

6. A substrate for electronic circuitry in accordance with claim 1, wherein the first filler component is a particle having a thermal conductivity of between 1 and 1,000,000 watts/(meter-°K).

7. A substrate for electronic circuitry in accordance with claim 1, wherein the first filler component is selected from a group consisting of aluminum oxide, spinel, silica, boron nitride, granular alumina, fumed alumina, silicon carbide, aluminum nitride, beryllium oxide, boron nitride coated aluminum oxide, boron nitride coated aluminum nitride and aluminum oxide coated aluminum nitride.

8. A substrate for electronic circuitry in accordance with claim 7, wherein the spinel is represented by a chemical formula AB204, wherein A is an element selected from a group consisting of cadmium, chromium, manganese, nickel, zinc, copper, cobalt, iron, magnesium, tin, titanium, and combinations of two or more of these, and wherein B is an element selected from a group consisting of chromium, iron, aluminum, nickel, manganese, tin, and combinations of two or more of these, and wherein O is oxygen.

9. A substrate for electronic circuitry in accordance with claim 8, wherein the spinel is activated and plated with a metal, to form an electrically conductive pathway.

10. A substrate for electronic circuitry in accordance with claim 1, wherein the first filler component is selected from a group consisting of ferroelectric fillers, fluoropolymer fillers and paraelectric fillers.

11. A substrate for electronic circuitry in accordance with claim 1, wherein the first filler component is an inorganic particle having a dielectric constant of between 10 and 50,000.

12. A substrate for electronic circuitry in accordance with claim 1, wherein the first filler component is selected from the group consisting of BaTiO3, SrTiO3, Mg2TiO4, Bi2(TiO3)3, PbTiO3, NiTiO3, CaTiO3, ZnTiO3, Zn2TiO4, BaSnO3, Bi(SnO3)3, CaSnO3, PbSnO3, MgSnO3, SrSnO3, ZnSnO3, BaZrO3, CaZrO3, PbZrO3, MgZnO3, SrZrO3, ZnZrO3, TiO2, Ta2O5, HfO2, Nb2O5, BaSrTiO3 and combinations of these.

13. A substrate for electronic circuitry in accordance with claim 1, wherein the first filler component is selected from a group consisting of ruthenium oxides, metals or metal oxides contained in Groups IIIA, IVA, VA, VIA or VIIA of the Periodic Table, metal carbides, metal nitrides, metal borides, lead magnesium niobate, barium nitride, aluminum nitride, electrically conductive carbon fibers or nanofibers, electrically conductive carbon nanotubes, diamond carbon powders, graphite, polyanilines, polypyrrole, polythiophene, polyphenylene, polyfuran, their copolymers, their polymer derivatives, and their doped polymer derivatives.

14. A substrate for electronic circuitry in accordance with claim 1, wherein the first or second filler component has an electrical conductivity of between 1×101 and 1×10100 mohs per meter.

15. A substrate for electronic circuitry in accordance with claim 1, wherein the first layer has an electrical resistivity between 1×101 and 1×1014 ohms per meter.

16. A substrate for electronic circuitry in accordance with claim 1, wherein the first or second filler component is selected from a group consisting of light activatable fillers, ferroelectric fillers, fluoropolymer fillers, paraelectric fillers, fluoropolymer fillers, electrically conductive inorganic particles, electrically conductive carbons and electrically conductive polymers.
